(19) United States
(12) Patent Application Publication
(10) Pub. No.: US 2021/0252991 A1
(43) Pub. Date: Aug. 19, 2021

(54) ELECTRIC VEHICLE CHARGING STATION AND METHOD OF CONTROLLING THE SAME

(71) Applicant: Ecamion Inc., Ontario (CA)

(72) Inventors: Carmine Pizzurro, Markham (CA); Himanshu Sudan, Toronto (CA); Rick Szymczyk, Whitby (CA); Reza Iravani, Toronto (CA); Dennis Burkov, Toronto (CA)

(21) Appl. No.: 16/972,226

(22) PCT Filed: Jun. 5, 2019
(86) PCT No.: PCT/CA2019/050779

§ 371 Date: Dec. 4, 2020

Related U.S. Application Data
(60) Provisional application No. 62/680,749, filed on Jun. 5, 2018.

(51) Int. Cl. B60L 53/62; B60L 53/16; B60L 53/66

(52) U.S. Cl. CPC B60L 53/62; B60L 2250/16; B60L 53/66; B60L 53/16

(57) ABSTRACT

A method comprises charging an electric vehicle using a connector connected at a first end to a direct current power source and at a second end to the electric vehicle, monitoring a state of charge of the electric vehicle, and when the state of charge exceeds a predefined state of charge level: disconnecting the first end of the connector from the direct current power source, connecting the first end of the connector to an alternating current source, and charging the electric vehicle using the connector connected at the first end to the alternating current source while the second end remains connected to the electric vehicle.

### CROSS-REFERENCE TO RELATED APPLICATIONS

This application claims priority to U.S. Provisional Patent Application No. 62/680,749 filed on Jun. 5, 2018, the entire contents of which are incorporated herein by reference.

### FIELD

This application relates to electric vehicles and in particular to an electric vehicle charging station and a method of controlling the same.

### BACKGROUND

Electric vehicle (EV) charging stations supply electric energy for the recharging of electric vehicles, such as for example plug-in electric vehicles. Some electric vehicles have onboard converters that can plug in to a standard electrical outlet or a high-capacity appliance outlet. Other electric vehicles require or can use a charging station that provides electrical conversion, monitoring, and/or safety functionality.

Charging stations provide special connectors that conform to a variety of competing standards. Common rapid charging standards include the Combined Charging System (CCS), CHAdeMO, and the Tesla Supercharger.

One challenge in charging station infrastructure is meeting the level of demand. For example, an isolated charging station along a busy highway may see hundreds of customers per hour, if every passing electric vehicle has to stop to charge. Accordingly, there is a need for electric vehicle charging stations that can service a high volume of electric vehicles.

A number of electric vehicle charging stations have been considered. For example, U.S. Pat. No. 8,717,170 discloses a method of management of electric vehicle charging station (EVCS) queues and an EVCS queue management system. The method comprises limiting access to the EVCS to an individual at the top of an EVCS queue during a changeover time. The changeover time may be predetermined or may be generated based upon data pertaining to the management of the queue and/or to the vehicle of the user at the top of the queue. If the user at the top of the queue fails to activate the EVCS during the changeover time, the next in line in the queue will be given a changeover time in which to reach the EVCS. If the queue is otherwise empty, the user at the top of the queue will be notified that the EVCS is no longer reserved, and that anyone may use the EVCS.

U.S. Pat. No. 9,346,365 discloses charge units for charging an electric vehicle and methods for cloud access and programming of data for charge units. In one example, a charging unit is connectable to a charge source (e.g., electricity) and has an connector (cord) for coupling the charge unit to the electric vehicle. The charge unit includes a port for interfacing with and charging an auxiliary battery. A display has a graphical user interface (GUI) for providing charge status information of a main battery of a vehicle and/or the auxiliary battery when connected to the port of the charge unit.

Although electric vehicle charging stations have been considered, improvements are desired. It is therefore an object at least to provide a novel electric vehicle charging station and a method of controlling the same.

### SUMMARY

It should be appreciated that this Summary is provided to introduce a selection of concepts in a simplified form that are further described below in the Detailed Description. This Summary is not intended to be used to limit the scope of the claimed subject matter.

Accordingly, in one aspect there is provided a method comprising: charging an electric vehicle using a connector connected at a first end to a direct current power source and at a second end to the electric vehicle; monitoring a state of charge of the electric vehicle; and when the state of charge exceeds a predefined state of charge level: disconnecting the first end of the connector from the direct current power source; connecting the first end of the connector to an alternating current source; and charging the electric vehicle using the connector connected at the first end to the alternating current source while the second end remains connected to the electric vehicle.

In one or more embodiments, the disconnecting comprises communicating a signal to open at least one switch intermediate the first end of the connector and the direct current power source.

In one or more embodiments, the connecting comprises communicating a signal to close at least one switch intermediate the first end the connector and the alternating current power source.

In one or more embodiments, the method further comprises prompting a user to select a rate of charge for charging the electric vehicle using the direct current power source, and charging the electric vehicle at the selected rate of charge.

In one or more embodiments, the method further comprises communicating a signal to selectively open or close at least one switch intermediate the first end of the connector and the direct current power source based at least on the selected rate of charge.

In one or more embodiments, a maximum rate of charge is determined based on a maximum rate of charge accepted by the electric vehicle.

In one or more embodiments, a maximum rate of charge is determined based on a maximum rate of charge available from the direct current power source.

In one or more embodiments, the method further comprises prior to charging the vehicle using the direct current power source, determining if the direct current power source is available, and if the direct current power source is not available, charging the vehicle using the alternating current power source until the direct current power source is available.

In one or more embodiments, the method further comprises communicating a notification to a mobile device of a user of the electric vehicle that the state of charge has exceeded the predefined state of charge level.

In one or more embodiments, the method further comprises prompting a user to select one of an exclusive charge and a non-exclusive charge, wherein the exclusive charge is uninterruptable and the non-exclusive charge is interruptible.

According to another aspect there is provided a system comprising: a direct current power source; an alternating current power source; a connector connectable at a first end to the direct current power source or the alternating current power source and at a second end to an electric vehicle; and a processor programmed to: charge the electric vehicle using the connector connected at the first end to the direct current power source and at the second end to the electric vehicle; monitor a state of charge of the electric vehicle; and when the state of charge exceeds a predefined state of charge level: disconnect the first end of the connector from the direct current power source; connect the first end of the connector to an alternating current source; and charge the electric vehicle using the connector connected at the first end to the alternating current source while the second end remains connected to the electric vehicle.

In one or more embodiments, the alternating power source comprises at least one battery generating direct current power; and an inverter changing the direct current power to alternating current power.

In one or more embodiments, the direct current power source comprises at least one battery generating direct current power.

In one or more embodiment, the direct current power source comprises a plurality of sets of batteries generating direct current power.

In one or more embodiments, the system further comprises a plurality of switches interconnecting the plurality of sets of batteries, wherein the processor is programmed to communicate signals to the plurality of switches to selectively connect the plurality of sets of batteries to one another in at least one of a series connection and a parallel connection.

In one or more embodiments, during the disconnecting, the processor is programmed to communicate a signal to open at least one switch intermediate the first end of the connector and the direct current power source.

In one or more embodiments, during the connecting, the processor is programmed to communicate a signal to close at least one switch intermediate the first end the connector and the alternating current power source.

In one or more embodiments, the processor is programmed to, prior to charging the vehicle using the direct current power source, determine if the direct current power source is available, and if the direct current power source is not available, charge the vehicle using the alternating current power source until the direct current power source is available.

In one or more embodiments, the processor is programmed to communicate a notification to a mobile device of the user of the electric vehicle that the state of charge has exceeded the predefined state of charge level.

In one or more embodiments, the processor is programmed to prompt a user to select a rate of charge for charging the electric vehicle using the direct current power source, communicate a signal to selectively open or close at least one switch intermediate the first end of the connector and the direct current power source based at least on the selected rate of charge, and charge the electric vehicle at the selected rate of charge.

In one or more embodiments, the processor is programmed to determine a maximum rate of charge based on a maximum rate of charge accepted by the electric vehicle.

In one or more embodiments, the processor is programmed to determine a maximum rate of charge based on a maximum rate of charge available from the direct current power source.

In one or more embodiments, the connector is a SAE J1772 connector having Combined Charging System capability.

According to another aspect there is provided a non-transitory computer readable medium having stored thereon computer program code executable by one or more processors to communicate a signal to charge an electric vehicle using a connector connected at a first end to a direct current power source and at a second end to an electric vehicle; monitor a state of charge of the electric vehicle, and when the state of charge exceeds a predefined state of charge level: communicate a signal to disconnect the first end of the connector from the direct current power source, communicate a signal to connect the first end of the connector to an alternating current source, and communicate a signal to charge the electric vehicle using the connector connected at the first end to the alternating current source while the second end remains connected to the electric vehicle.

According to another aspect there is provided a method comprising detecting a connection between an electric vehicle and an electric vehicle charging station; prompting a user to select an exclusive charge or a non-exclusive charge; determining a maximum rate of charge based on the selection; and charging the electric vehicle using the electric vehicle charging station at the maximum rate of charge.

In one or more embodiments, when the user selects the exclusive charge, the determining comprises setting the maximum rate of charge as the maximum rate of charge accepted by the electric vehicle when the maximum rate of charge accepted by the electric vehicle is available at the electric vehicle charging station without interrupting electric vehicles being charged non-exclusively.

In one or more embodiments, when the user selects the exclusive charge, the determining comprises: determining a maximum rate of charge available at the electric vehicle charging station by summing a rate of charge available at the electric vehicle charging station and rates of charge being used by other electric vehicles non-exclusively

In one or more embodiments, the method further comprises setting the maximum rate of charge as the maximum rate of charge accepted by the electric vehicle when the maximum rate of charge available at the electric vehicle charging station is greater than the maximum rate of charge accepted by the electric vehicle.

In one or more embodiments, the method further comprises setting the maximum rate of charge as the maximum rate of charge available at the electric vehicle charging station when the maximum rate of charge available at the electric vehicle charging station is less than the maximum rate of charge accepted by the electric vehicle.

In one or more embodiments, the method further comprises executing a switching sequence to charge the electric vehicle at the maximum rate of charge.

### BRIEF DESCRIPTION OF THE DRAWINGS

Embodiments will now be described more fully with reference to the accompanying drawings in which:

FIG. 1 is a schematic diagram of an electric vehicle charging station;

FIG. 2 is a schematic diagram of an energy storage unit forming part of the electric vehicle charging station of FIG. 1;

FIG. 3 is another schematic diagram of an energy storage unit forming part of the electric vehicle charging station of FIG. 1;

FIG. 4 is a schematic diagram of a charging terminal forming part of the electric vehicle charging station of FIG. 1;

FIG. 5 is a front view of a connector forming part of the electric vehicle charging station of FIG. 1;

FIG. 6 is a flowchart of a method for charging an electric vehicle;

FIG. 7 is a flowchart of a method for determining a maximum rate of charge;

FIG. 8 is a flowchart of a method for determining three levels of charging;

FIG. 9 is a flowchart of a method for switching between a Level 2 and a Level 3 charge;

FIG. 10 is a flowchart of another method for charging an electric vehicle; and

FIG. 11 is a flowchart of another method for determining a maximum rate of charge.

### DETAILED DESCRIPTION OF THE EMBODIMENTS

The foregoing summary, as well as the following detailed description of certain examples will be better understood when read in conjunction with the appended drawings. As used herein, an element or feature introduced in the singular and preceded by the word “a” or “an” should be understood as not necessarily excluding the plural of the elements or features. Further, references to “one example” or “one embodiment” are not intended to be interpreted as excluding the existence of additional examples or embodiments that also incorporate the described elements or features. Moreover, unless explicitly stated to the contrary, examples or embodiments “comprising” or “having” or “including” an element or feature or a plurality of elements or features having a particular property may include additional elements or features not having that property. Also, it will be appreciated that the terms “comprises”, “has”, “includes” means “including by not limited to” and the terms “comprising”, “having” and “including” have equivalent meanings.

As used herein, the term “and/or” can include any and all combinations of one or more of the associated listed elements or features.

It will be understood that when an element or feature is referred to as being “on”, “attached” to, “connected” to, “coupled” with, “contacting”, etc. another element or feature, that element or feature can be directly on, attached to, connected to, coupled with or contacting the other element or feature or intervening elements may also be present. In contrast, when an element or feature is referred to as being, for example, “directly on”, “directly attached” to, “directly connected” to, “directly coupled” with or “directly contacting” another element of feature, there are no intervening elements or features present.

It will be understood that spatially relative terms, such as “under”, “below”, “lower”, “over”, “above”, “upper”, “front”, “back” and the like, may be used herein for ease of description to describe the relationship of an element or feature to another element or feature as illustrated in the figures. The spatially relative terms can however, encompass different orientations in use or operation in addition to the orientation depicted in the figures.

A Level 2 charge is defined by the Society of Automotive Engineers (SAE) standard as being an alternating current (AC) charge at 240V_{AC}, single phase, at a frequency of 60 Hz. Level 3 charging is commonly referred to as DC fast charging and is generally recognized as being a direct current (DC) charge between 200V_{DC} and 1000V_{DC}.

In the following, an electric vehicle (EV) charging station is described. The EV charging station is capable of automatically switching to Level 2 charging after a Level 3 charging cycle is complete. Specifically, the EV charging station is programmed to switch between Level 2 and Level 3 charging to ensure the amount of power available is shared amongst EVs requesting a charge and to maximize the utilization of charging resources while charging multiple EVs.

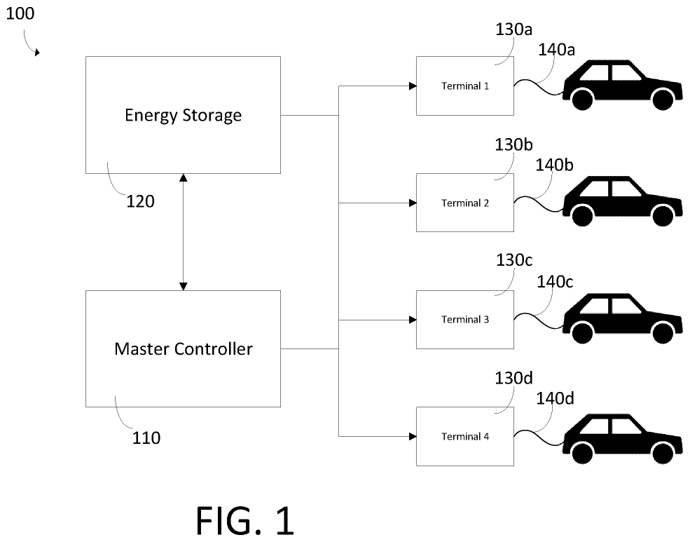

Turning now to FIG. 1, an electric vehicle (EV) charging station is shown and is generally identified by reference numeral 100. As can be seen, the EV charging station 100 comprises a master controller 110, an energy storage unit 120, charging terminals 130a, 130b, 130c, 130d and connectors 140a, 140b, 140c, 140d. The master controller 110 bi-directionally communicates with the energy storage unit 120 and each charging terminal 130a, 130b, 130c, 130d. The energy storage unit 120 bi-directionally communicates with the master controller 110 and is electrically connected to each charging terminal 130a, 130b, 130c, 130d. Each charging terminal 130a, 130b, 130c, 130d is electrically connected to a respective one of the connectors 140a, 140b, 140c, 140d. Each connector 140a, 140b, 140c, 140d is connectable to an electric vehicle (EV) for charging the battery system thereof. When a respective connector is connected to an EV, the corresponding charging terminal bi-directionally communicates with a control system of the EV.

The master controller 110 in this embodiment is a programmed computer or other suitable processing device comprising, for example, a processing unit comprising one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The master controller may also comprise networking capabilities using Ethernet, Wi-Fi, and/or other suitable network format, to enable connection to shared or remote drives, one or more networked computers, or other networked devices. In this embodiment, the master controller 110 bi-directionally communicates with the energy storage unit 120 and each charging terminal 130a, 130b, 130c, 130d.

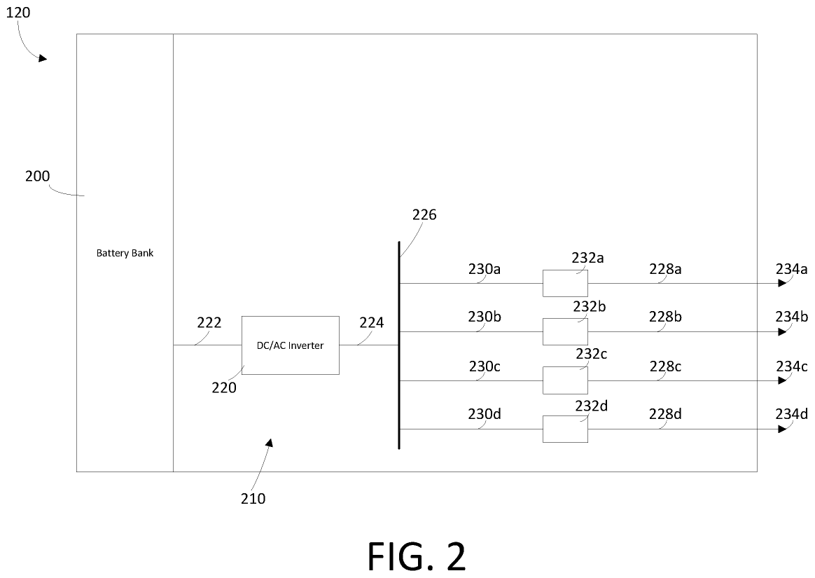

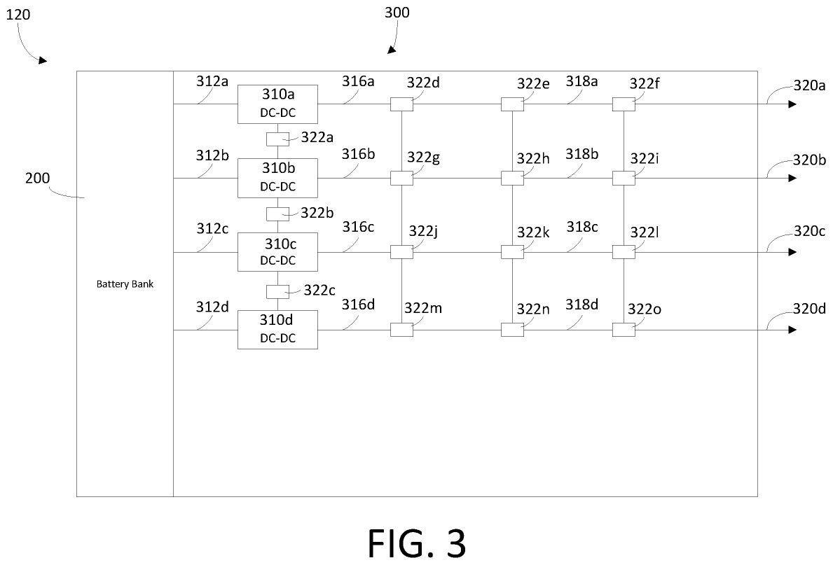

As shown in FIGS. 2 and 3, the energy storage unit 120 comprises a battery bank 200, an alternating current (AC) output module 210, and a direct current (DC) output module 300.

In this embodiment, the battery bank 200 comprises five (5) battery strings (not shown) coupled to a battery management system (not shown). In this embodiment, each battery string comprises twelve (12) battery modules connected in series. Each battery module comprises a plurality of lithium-ion cells. Further specifics of the battery bank 200 are described in U.S. Pat. No. 9,812,689 to Pizzurro et al, the relevant portions of which are incorporated herein by reference. Although not shown, the battery bank is connected to the power grid and receives power therefrom for charging the battery bank when required.

In this embodiment, each battery module has an output of approximately 50V_{DC}. Since the twelve (12) battery modules are connected in series, the output voltage of each battery string is 600V_{DC} and, when operating alone, is capable of providing a 60 kW Level 3 charge to an EV, as will be described.

As shown in FIG. 2, the AC output module 210 comprises an inverter 220 electrically connected at a first end 222 to one of the battery strings of the battery bank 200. The inverter 220 inverts DC power received from the battery string to AC power. In this embodiment, the inverter 220 receives 600V_{DC} from the battery bank 200 and inverts this to 240V_{AC}, single phase at 60 Hz. As such, the AC output module 210 is capable of providing Level 2 charging. As will be appreciated, in another embodiment the AC output module 210 may be directly connected to a power grid and thus would not require an inverter.

A second end 224 of the inverter 220 is electrically connected to an AC bus 226. The AC bus 226 is electrically connected to a first end 230a, 230b, 230c, 230d of a number of AC output lines 228a, 228b, 228c and 228d. A second end 234a, 234b, 234c, 234d of each AC output line 228a, 228b, 228c, 228d is connected to a respective charging terminal 130a, 130b, 130c, 130d.

In this embodiment, four (4) switches 232a, 232b, 232c, 232d are used to selectively connect or disconnect the first end 230a, 230b, 230c, 230d of each AC output line 228a, 228b, 228c, 228d to the second end 234a, 234b, 234c, 234d of each AC output line 228a, 228b, 228c, 228d. Although not shown, each switch 232a, 232b, 232c, 232d is connected to the master controller 110 and receives command signals therefrom to selectively open or close. When the switch 232a, 232b, 232c, 232d is closed, the first end 230a, 230b, 230c, 230d is electrically connected to the second end 234a, 234b, 234c, 234d. When the switch 232a, 232b, 232c, 232d is open, the first end 230a, 230b, 230c, 230d is electrically disconnected from the second end 234a, 234b, 234c, 234d. As will be described, by selectively opening or closing the switches 232a, 232b, 232c, 232d, energy delivered through each AC output line 228a, 228b, 228c, 228d is controlled.

For example, to deliver energy through one of the AC output lines 228a, 228b, 228c, 228d the master controller 110 communicates a signal to close a respective switch 232a, 232b, 232c, 232d. In response, the respective switch 232a, 232b, 232c, 232d closes and thus energy capable of providing a Level 2 charge is delivered through the AC output line 228a, 228b, 228c, 228d.

As shown in FIG. 3, the DC output module 300 comprises a number of converters, which in this embodiment is four (4) converters 310a, 310b, 310c and 310d. Each converter 310a, 310b, 310c, 310d is electrically connected at a first end 312a, 312b, 312c, 312d to a respective battery string of the battery bank 200. Each convertor 310a, 310b, 310c, 310d converts DC power received from the respective battery string at a first voltage level V₁ to a second voltage level V₂. In this embodiment, the first voltage level V₁ is 600 V_{DC}. The second voltage level V₂ is determined based on a request from the user of the EV, up to a maximum of 500 V_{DC} as will be described. When operating alone, each converter is capable of providing Level 3 charging up to 60 kW (at 500V_{DC}×120 A_{DC}).

Each convertor 310a, 310b, 310c, 310d is electrically connected to a first end 316a, 316b, 316c, 316d of a DC output line 318a, 318b, 318c, 318d. A second end 320a, 320b, 320d, 320c of each DC output line 318a, 318b, 318c, 318d is connected to a respective charging terminal 130a, 130b, 130c, 130d.

In this embodiment, a number of switches, in this embodiment fifteen (15) switches 322a to 322o, are used to selectively connect or disconnect the DC output lines 318a, 318b, 318c, 318d and converters 310a, 310b, 310c, 310d to one another. Specifically, switch 322a is used to selectively connect or disconnect converter 310a to converter 310b. Switch 322b is used to selectively connect or disconnect converter 310b to converter 310c. Switch 322c is used to selectively connect or disconnect converter 310c to converter 310d. Switches 322d to 322o form a 3×4 switch matrix wherein three of the switches 322d to 322o extend along a respective DC output line 318a, 318b, 318c, 318d. In this configuration, the three of the switches 322d to 322o form a row and are connected in series. As can be seen, each one of the three switches 322d to 322o on each DC output line 318a, 318b, 318c, 318d forms a column with the other of the three switches 322d to 322o. Each column of switches 322d to 322o is connected in series. Although not shown, each switch 322d to 322o is connected to the master controller 110 and receives command signals therefrom to selectively open or close. By selectively opening or closing the switches 322d to 322o, the amount of energy delivered through each DC output line 318a, 318b, 318c, 318d is controlled.

For example, in the event that a 60 kW Level 3 charge is requested through DC output line 318a, the master controller 110 communicates a signal to close switches 322d, 322e and 322f. The master controller 110 also communicates a signal to ensure switch 322a is open. As such, energy capable of providing a 60 kW Level 3 charge is delivered through DC output line 318a. Table 1 provides examples of switching sequences that can be utilized by the master controller 110 to adjust the amount of energy delivered through DC output line 318a. In Table 1, the state of each switch is indicated in binary. A state of “0” indicates that the switch is open and a state of “1” indicates that the switch is closed.

TABLE 1
Switching Sequence for Various Levels of Level 3 Charging

| | 500 V_{DC} × | 500 V_{DC} × | 1000 V_{DC} × | 1000 V_{DC} × |
|---|---|---|---|---|
| | 120 A_{DC} | 240 A_{DC} | 120 A_{DC} | 240 A_{DC} |
| Switch | State | State | State | State |
| 322a | 0 | 0 | 1 | 1 |
| 322b | 0 | 0 | 0 | 0 |
| 322c | 0 | 0 | 0 | 1 |
| 322d | 1 | 1 | 1 | 1 |
| 322e | 1 | 1 | 1 | 1 |
| 322f | 1 | 1 | 1 | 1 |
| 322g | 0 | 1 | 0 | 0 |
| 322h | 0 | 0 | 0 | 0 |
| 322i | 0 | 0 | 0 | 1 |
| 322j | 0 | 0 | 0 | 1 |
| 322k | 0 | 0 | 0 | 1 |
| 322l | 0 | 0 | 0 | 1 |
| 322m | 0 | 0 | 0 | 0 |
| 322n | 0 | 0 | 0 | 0 |
| 322o | 0 | 0 | 0 | 0 |

As will be appreciated, the switching states for DC output lines 318b, 318c and 318d are similar to that of DC output line 318a (shown in Table 1) and as such the specifics will not be described. Further, the switching states shown in Table 1 are examples and additional switching states may be used.

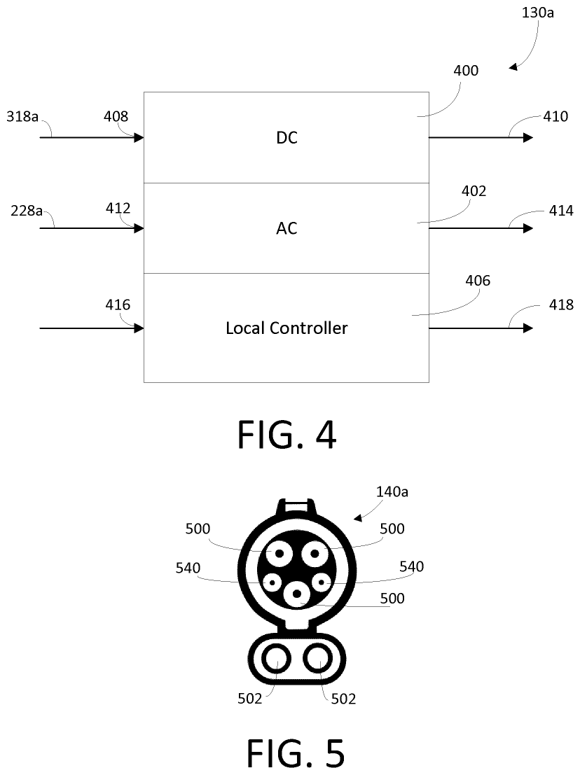

Charging terminal 130a is shown in FIG. 4. As can be seen, charging terminal 130a comprises a DC delivery module 400, an AC delivery module 402 and a local controller 406.

The DC delivery module 400 is connected at a first end 408 to the DC output line 318a of the DC output module 300 and at a second end 410 to connector 140a. Similarly, the AC delivery module 402 is connected at a first end 412 to the AC output line 228a of the AC output module 210 and at a second end 414 to connector 140a.

The local controller 406 in this embodiment is a programmable computer or other suitable processing device comprising, for example, a processing unit comprising one or more processors, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The local controller 406 may also comprise networking capabilities using Ethernet, Wi-Fi, and/or other suitable network format, to enable connection to shared or remote drives, one or more networked computers, or other networked devices. The local controller 406 max also comprise cellular capabilities to communicate messages such as text messages to mobile devices. The local controller 406 is coupled to a display screen (not shown) which in this embodiment is a touch screen device used to display information to a user and to receive input from the user, as will be described. The local controller 406 is connected at a first end 416 to the master controller 110 and at a second end 418 to the connector 140a. The local controller 406 bi-directionally communicates with the master controller 110. When the connector 140a is connected to an EV, the local controller 406 bi-directionally communicates with the control system of the EV to exchange information and to communicate control signals. As will be appreciated, charging terminals 130b, 130c, 130d are generally identical to that of charging terminal 130a.

Connector 140a is shown in FIG. 5. In this embodiment, the connector 140a is in the form of a SAE J1772 connector having Combined Charging System (CCS) capability. Specifically, connector 140a comprises three AC pins 500 electrically connected to the AC delivery module 402 of the charging terminal 130a. The connector 140a comprises two DC pins 502 electrically connected to the DC delivery module 400 of the charging terminal 130a. The connector comprises two communication pins 540 connected to the local controller 406. When connected to an EV, the connector 140a provides DC charging to the EV battery system (via DC pins 502) or AC charging to the EV on-board charger (via AC pins 500). The connector 140a enables bi-directional communication between the local controller 406 and the control system of the EV via communication pins 540. As will be appreciated, in this embodiment connectors 140b, 140c, 140d are generally identical to that of connector 140a.

As mentioned, the EV charging station 100 can switch between DC fast charging and AC charging while the connector remains connected to the EV. Put another way, the EV charging station 100 can switch between Level 3 charging and Level 2 while the connector remains connected to the EV.

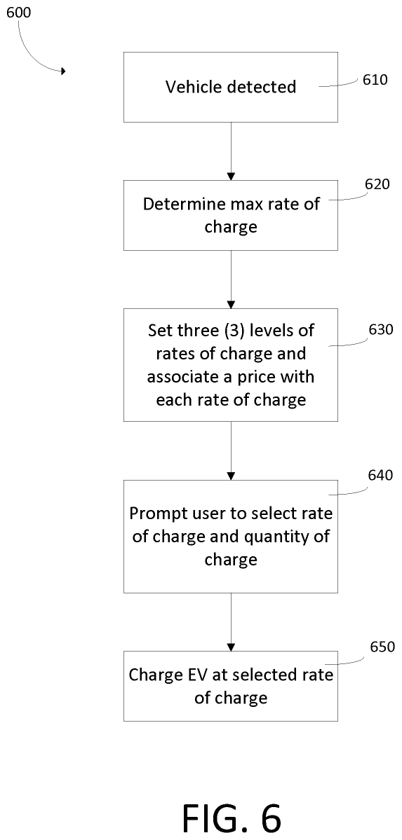

During operation, the EV charging station 100 performs a method as outlined in FIG. 6 and identified by reference numeral 600. As can be seen, method 600 begins each time an EV is detected as a result of one of the connectors 140a, 140b, 140c, 140d being plugged into an EV (step 610). Once the EV is detected, the control system of the EV and the local controller 406 of the charging terminal 130a exchange information via the two communication pins 540. The control system of the EV provides the local controller 406 with information such as the make of the EV, the model of the EV and the current state of charge of the battery system of the EV. In this embodiment, the control system of the EV provides the local controller 406 with the user's cell phone number so that the local controller 406 can communicate text messages to the user. As will be appreciated, information received by the local controller 406 is communicated to the master controller 110.

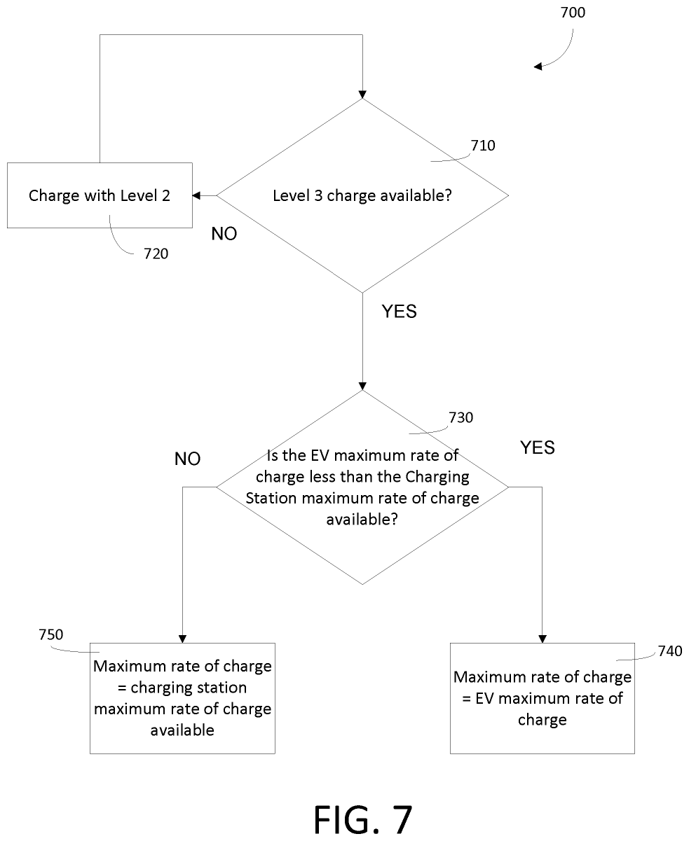

The maximum rate of charge available is determined (step 620). In this embodiment, the maximum rate of charge available is determined according to a method 700 shown in FIG. 7. A check is performed to determine if Level 3 charging is available (step 710). If Level 3 charging is not available, the EV is charged at Level 2 until Level 3 is available (step 720). To charge the EV at Level 2, the local controller 406 communicates a signal to the control system of the EV that a Level 2 charge is going to begin. The control system of the EV ensures the EV is ready to accept a Level 2 charge and communicates this to the local controller 406. The local controller 406 communicates this information to the master controller 110, which in turn executes a switching sequence on the AC output module 210 to ensure a Level 2 charge is provided to the EV.

If, at step 710, it is determined that a Level 3 charge is available, the maximum rate of charge accepted by the particular model of the EV is compared to the maximum rate of charge available from the EV charging station 100 (step 730). If the maximum rate of charge accepted by the particular model of the EV is less than that available from the EV charging station 100, then the maximum rate of charge is set as the maximum rate of charge accepted by the particular model of the EV (step 740). If the maximum rate of charge available from the EV charging station 100 is less than the maximum rate of charge accepted by the particular model of the EV, then the maximum rate of charge is set as the maximum rate of charge available from the EV charging station 100 (step 750).

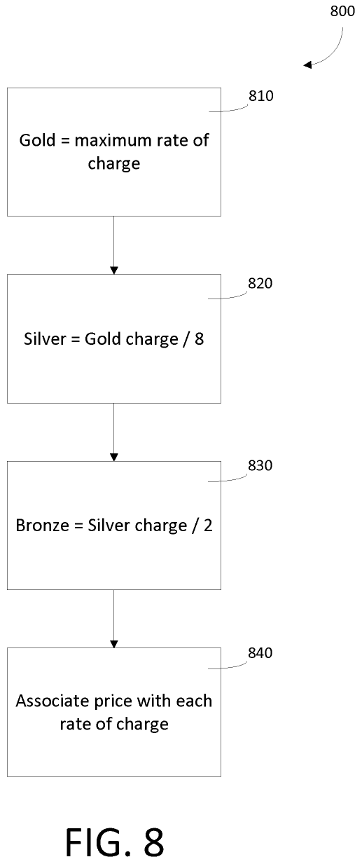

Once the maximum rate of charge available is determined, the master controller 110 determines different rates of charging the EV at Level 3 (step 630). In this embodiment, there are three options available, which are determined according to a method 800 shown in FIG. 8. As can be seen, the maximum rate of charge available is identified as a Gold Charge (step 810). The second rate of charge is set as a Silver Charge and is calculated by dividing the Gold Charge by eight (8) (step 820). The third rate of charge is set as a Bronze Charge and is calculated by dividing the Silver Charge by two (2) (step 830). A price is associated with each rate of charge and is calculated per kilowatt hour (kWh) based on a market rate or based on demand (step 840).

The options for charging the EV at Level 3 and the price associated with each rate of charge is communicated to the local controller 406. The local controller 406 in turn displays the three rates of charge, the price associated with each rate of charge, and a desired quantity of charge on the display screen (step 640). The display screen displays a message to the user to select the rate of charge and then select the quantity of charge (step 640). As mentioned previous, the rate of charge options are Gold, Silver or Bronze. In this embodiment, the quantity of charge is displayed in kilometers (km) and is calculated based on vehicle information received from the control system of the EV.

Once the user has selected a rate of charge and quantity of charge, using the touch screen functionality of the display device, the local controller 406 communicates this information to the master controller 110. The EV is then charged at the selected rate of charge (step 650). Specifically, in this embodiment, once the selected rate of charge is communicated to the master controller 110, the master controller 110 executes a switching sequence on the DC output module 300 to ensure the selected rate of charge is provided to the EV. Examples of switching sequences are provided above in Table 1. At the same time, the local controller 406 communicates to the control system of the EV that it will be receiving a Level 3 charge. In response, the control system of the EV ensures the EV is ready to accept a Level 3 charge and communicates this to the local controller 406. As a result, the EV begins charging at the selected rate of charge. The local controller 406 displays an estimated time to complete the requested quantity of charge on the display screen.

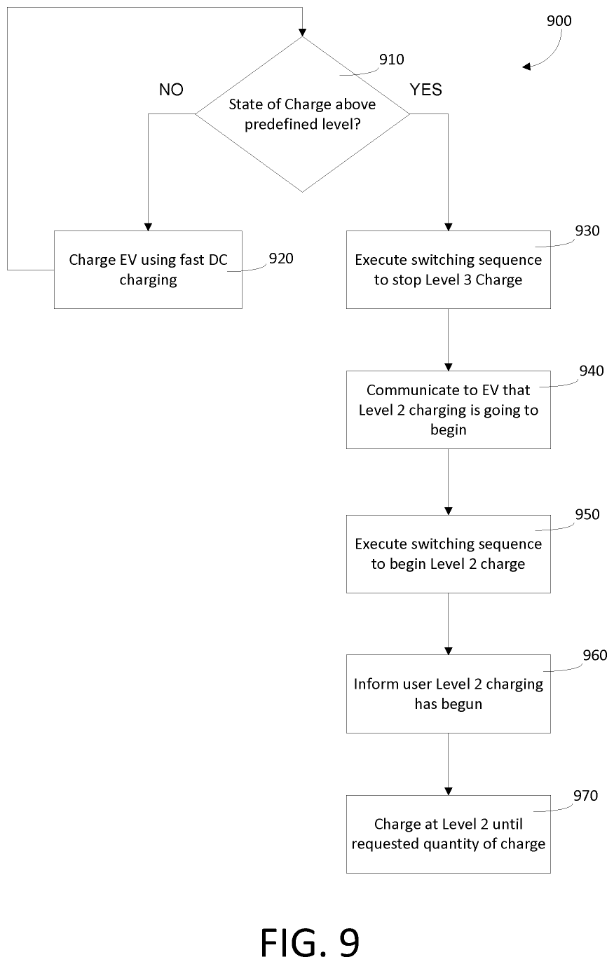

During charging, the local controller 406 monitors the state of charge of the EV according to a method 900, shown in FIG. 9. Specifically, the local controller 406 continuously receives charging information from the control system of the EV. A check is performed to determine if the state of charge of the EV is above a predefined level, which in this embodiment is 80% of the requested quantity of charge (step 910). If the state of charge is below the predefined level, the EV continues to charge at the selected rate of charge, which is a Level 3 charge (step 920). If the state of charge is above the predefined level, the local controller 406 communicates this information to the master controller 110. The master controller 110 in turn executes a switching sequence on the DC output module to stop charging the EV using Level 3 charging and to start charging the EV using Level 2 charging (step 930). As will be appreciated, this is done automatically without disconnecting the connector from the EV. The local controller 406 communicates information to the control system of the EV indicating that the Level 3 charge has stopped, and that a Level 2 charge is going to begin (step 940). The control system of the EV ensures the EV is ready to accept a Level 2 charge and communicates this to the local controller 406. The local controller 406 communicates this information to the master controller 110, which in turn executes a switching sequence on the AC output module 210 to ensure a Level 2 charge is provided to the EV (step 950). The local controller 406 communicates to the user via text message that the Level 3 charge is complete, and that the EV is now charging using a Level 2 charge (step 960). The charging then continues until the EV has been charged to the requested quantity of charge (step 970).

As outlined above, once the EV has charged to 80% of a full charge using Level 3 charging, the EV charging station 100 charges the remaining 20% of the full charge using Level 2 charging. As this is done without removing the connector, the user is not required to come back to their vehicle to change connectors to switch from a Level 3 charge to a Level 2 charge. Further, the user is sent information indicating that their EV has been charged to 80% of the requested quantity of charge. The user then has the option to return to their EV or to wait until the Level 2 charge is complete. As will be appreciated, this ensures Level 3 charging resources are available for other EV's that need to charge using the EV charging station 100, in particular EV's that have a low charge level.

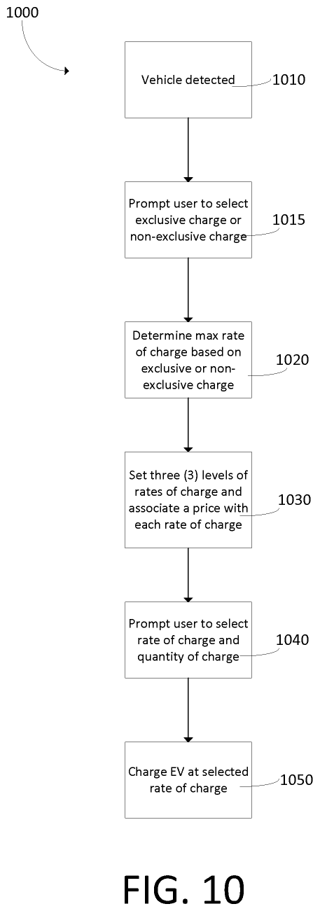

Turning now to FIG. 10, another embodiment of method performed by the EV charging station 100 is shown and is generally identified using reference numeral 1000. As will be described, method 1000 is generally similar to that of method 600 with the following exceptions.

During method 1000, once the vehicle is detected (step 1010), the local controller communicates with the display screen to display a message to prompt the user to select an exclusive charge or a non-exclusive charge (step 1015). In this embodiment, an exclusive charge is defined as a charge that cannot be interrupted by another EV. A non-exclusive charge is defined as a charge that can be interrupted by another EV. If a user chooses the exclusive charge, the charging station maximum rate of charge available to others is reduced. As will be appreciated, an exclusive charge is offered at a higher price than a non-exclusive charge.

The maximum rate of charge available is determined based on whether the user has selected an exclusive charge or a non-exclusive charge (step 1020). If a non-exclusive charge is selected, the maximum rate of charge is determined in a manner similar to that of method 700 described above with reference to FIG. 7 and the method continues to step 1030. If no charge is available, the master controller communicates this information and the display screen informs the user that no charging is available and may also indicate how long the user must wait until charging is available.

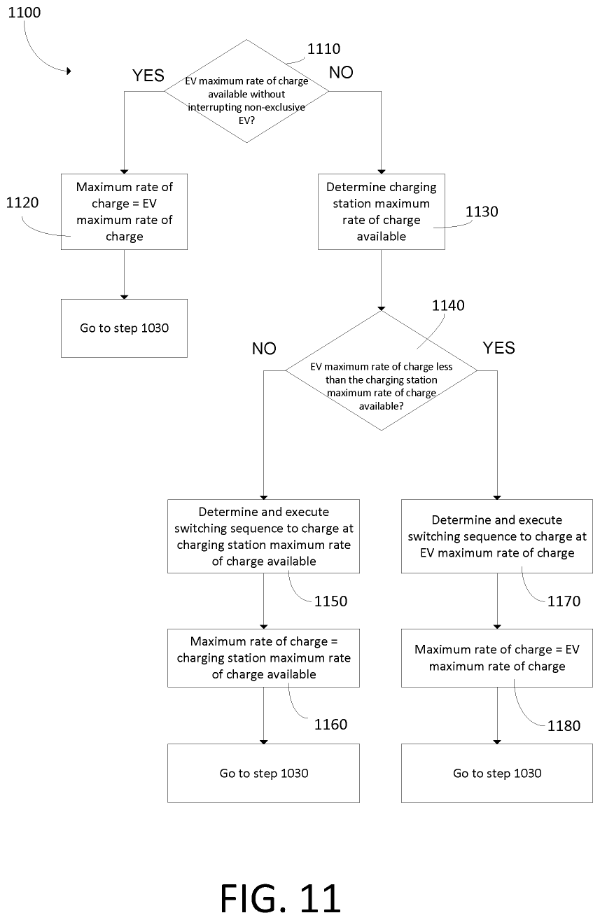

If an exclusive charge is selected, the master controller executes a method 1100 shown in FIG. 11. During method 1100, a check is performed to determine if the EV maximum rate of charge is available without interrupting other EVs that are charging non-exclusively (step 1110). If the EV maximum rate of charge is available without interrupting other EVs that are charging non-exclusively, the maximum rate of charge is set as the EV maximum rate of charge (step 1120) and the method continues to step 1030.

If the EV maximum rate of charge is not available without interrupting other EVs that are charging non-exclusively, the master controller determines the charging station maximum rate of charge available (step 1130). In this embodiment, the charging station maximum rage of charge available is determined by summing the rate of charge currently not being used and the rate(s) of charge being used by other EVs non-exclusively. If the EV maximum rate of charge is greater than the charging station maximum rate of charge available (step 1140), then the master controller determines and executes a switching sequence to charge the EV at the charging station maximum rate of charge available (step 1150). The maximum rate of charge is set as the charging station maximum rate of charge available (step 1160) and the method continues to step 1030.

If the EV maximum rate of charge is less than the charging station maximum rate of charge available (step 1140), then the master controller determines and executes a switching sequence to charge the EV at the EV maximum rate of charge (step 1170). The maximum rate of charge is set as the EV maximum rate of charge (step 1180) and the method continues to step 1030.

Once the maximum rate of charge has been determined (step 1020), the method continues to steps 1030, 1040 and 1050 which are generally identical to that of steps 630, 640 and 650 of method 600 described above, respectively.

Examples of the charging station executing method 1000 will now be described. A first EV (“EV1”) drives up to terminal 130a and connects. EV1 is detected and the user requests a non-exclusive charge at the gold level (maximum rate of charge). In this example, the maximum rate of charge accepted by EV1 is 1000 V_{DC}×240 A_{DC}. As such, the master controller 110 executes a switching sequence as outlined in Table 2:

TABLE 2
EV1 charging at 1000 V_{DC} × 240 A_{DC}

| Switch | State |
|---|---|
| 322a | 1 |
| 322b | 0 |
| 322c | 1 |
| 322d | 1 |
| 322e | 1 |
| 322f | 1 |
| 322g | 0 |
| 322h | 0 |
| 322i | 1 |
| 322j | 1 |
| 322k | 1 |
| 322l | 1 |
| 322m | 0 |
| 322n | 0 |
| 322o | 0 |

As a result of the switching sequence, EV1 receives 1000 V_{DC}×240 A_{DC} non-exclusively. As will be appreciated, terminal 130a is being used by EV1. Terminals 130b, 130c and 130d are available for use by other EVs and as such an “available” message is shown on the display screen to indicate the status thereof.

A second EV (“EV2”) drives up to terminal 130c and connects. EV2 is detected and the user requests an exclusive charge at the gold level (maximum rate of charge). In this example, the maximum rate of charge accepted by EV2 is 1000 V_{DC}×120 A_{DC}. Since EV1 is charging non-exclusively and the amount of charge requested by EV2 is greater than that currently available, the master controller 110 executes a switching sequence to reduce power output to EV1 to ensure EV2 receives the requested power. The resulting switching sequence is shown in Table 3:

TABLE 3
EV1 charging at 1000 V_{DC} × 120 A_{DC},
EV2 charging at 1000 V_{DC} × 120 A_{DC}

| Switch | State |
|---|---|
| 322a | 1 |
| 322b | 0 |
| 322c | 1 |
| 322d | 1 |
| 322e | 1 |
| 322f | 1 |
| 322g | 0 |
| 322h | 0 |
| 322i | 0 |
| 322j | 1 |
| 322k | 1 |
| 322l | 1 |
| 322m | 0 |
| 322n | 0 |
| 322o | 0 |

As a result of the switching sequence, EV1 receives 1000 V_{DC}×120 A_{DC} non-exclusively and EV2 receives 1000 V_{DC}×120 A_{DC} exclusively. As will be appreciated, terminal 130a is being used by EV1 and terminal 130c is being used by EV2. Since terminal 130a is non-exclusive, terminal 130b is available for use by other EVs and as such an “available” message is shown on the display screen to indicate the status thereof. Since terminal 130c is exclusive, terminal 130d is not available for use by other EVs and as such a message such as “available for use in X minutes” is shown on the display screen thereof, where X indicates the amount of time left to charge EV2.

A third EV (“EV3”) drives up and the user sees that terminal 130d is not available for use. EV3 then drives to terminal 130b and connects. EV3 is detected and the user requests an exclusive charge at the gold level (maximum rate of charge). In this example, the maximum rate of charge accepted by EV3 is 1000 V_{DC}×240 A_{DC}. However, since EV2 is charging exclusively, the maximum rate of charge available to EV3 is 1000 V_{DC}×120 A_{DC}. Since EV1 is charging non-exclusively and EV2 is charging exclusively, the master controller 110 executes a switching sequence to stop charging EV1 and to start charging EV3. The resulting switching sequence is shown in Table 4:

TABLE 4
EV1 not charging, EV2 charging at 1000 V_{DC} × 120
A_{DC}, EV3 charging at 1000 V_{DC} × 120 A_{DC}

| Switch | State |
|---|---|
| 322a | 1 |
| 322b | 0 |
| 322c | 1 |
| 322d | 0 |
| 322e | 0 |
| 322f | 0 |
| 322g | 1 |
| 322h | 1 |
| 322i | 1 |
| 322j | 1 |
| 322k | 1 |
| 322l | 1 |
| 322m | 0 |
| 322n | 0 |
| 322o | 0 |

As a result of the switching sequence, EV1 does not receive any power, EV2 receives 1000 V_{DC}×120 A_{DC} exclusively and EV3 receives 1000 V_{DC}×120 A_{DC} exclusively. As will be appreciated, terminal 130a is being used by EV1, terminal 130b is being used by EV3, terminal 130c is being used by EV2. Since terminal 130b is exclusive, terminal 130a is not available for use by EV1 and indicates “available for use in X minutes” on the associated display screen, where X indicates the amount of time to charge EV3. Since terminal 130c is exclusive, terminal 130d is not available for use by other EVs and indicates “available for use in X minutes” on the associated display screen, where X indicates the amount of time left to charge EV2.

Once EV3 has completed charging (assuming EV3 charges quicker than EV2 and no new EVs have connected), the master controller executes a switching sequence to return to that shown in Table 3 to continue charging EV1.

Once EV2 has completed charging (assuming EV2 charges quicker than EV1 and no new EVs have connected), the master controller executes a switching sequence to return to that shown in Table 2 to continue charging EV1.

Although in embodiments the user is required to choose between an exclusive charge and a non-exclusive charge and is then required to choose three levels of charging (gold, silver, bronze), those skilled in the art will appreciate than in other embodiments the user may only be required to choose between an exclusive charge and a non-exclusive charge.

Although in embodiments the energy storage unit is described as having a battery bank comprising five (5) battery strings, those skilled in the art will appreciate that alternatives are available. For example, in another embodiment, the energy storage unit may have a battery bank comprising nine (9) battery strings. In this embodiment, eight (8) of the battery strings are used for Level 3 charging, and one (1) of the battery strings is used for Level 2 charging. In another embodiment, the energy storage unit may have a battery bank comprising eight (8) battery strings. In this embodiment, the eight (8) battery strings are used for Level 3 charging. Level 2 charging may be provided by connecting the AC output lines directly to the power grid.

Although in embodiments the predefined level for switching between Level 3 and Level 2 charging is set at 80% of a full charge, those skilled in the art that other values may be used such as for example 50% of a full charge, 75% of a full charge, 90% of a full charge, etc.

Although in embodiments the, each converter is described as providing Level 3 charging up to 60 kW (at 500 V_{DC}×120 A_{DC}), those skilled in the art will appreciate that other values for voltage and/or current may be used. For example, in another embodiment, the current provided may be 180 A_{DC} or 200 A_{DC}. Other voltage levels may also be provided. These values may be configured based on EV demand or user demand.

Although in embodiments the charging station is described as using connectors in the form of SAE J1772 connectors having Combined Charging System (CCS) capability, those skilled in the art will appreciate that additional or alternative connector types may be used. For example, the charging station may additionally or alternatively comprise CHAdeMO connectors.

Although in embodiments, the control system of the EV is used to provide the local controller with information such as the make of the EV and the model of the EV, those skilled in the art will appreciate that alternatives are available. For example, in another embodiment, the charging station may comprise a camera connected to the master controller. In this embodiment, when an EV drives up to the charging station, the camera may take a picture of the EV. The picture may then be processed to identify physical features of the EV. The identified physical features may then be compared to a database of EV's to identify the make and model of the EV. Once the EV has been identified, this information may be used to enhance the user experience. For example, in embodiments where multiple connector types are available, the type of connector required to charge the EV may be illuminated to simply the charging process for the user. In other embodiments, the charging station may communicate and exchange information with the EV using Bluetooth or WiFi.

Further, the disclosure comprises embodiments according to the following clauses:
Clause 1. A method comprising:

charging an electric vehicle using a connector connected at a first end to a direct current power source and at a second end to the electric vehicle;

monitoring a state of charge of the electric vehicle; and

when the state of charge exceeds a predefined state of charge level:
disconnecting the first end of the connector from the direct current power source;
connecting the first end of the connector to an alternating current source; and
charging the electric vehicle using the connector connected at the first end to the alternating current source while the second end remains connected to the electric vehicle.
Clause 2. The method of clause 1 wherein the disconnecting comprises communicating a signal to open at least one switch intermediate the first end of the connector and the direct current power source.
Clause 3. The method of clause 1 or 2 wherein the connecting comprises communicating a signal to close at least one switch intermediate the first end the connector and the alternating current power source.
Clause 4. The method of any one of clauses 1 to 3 further comprising:

prompting a user to select a rate of charge for charging the electric vehicle using the direct current power source; and

charging the electric vehicle at the selected rate of charge.
Clause 5. The method of clause 4, further comprising communicating a signal to selectively open or close at least one switch intermediate the first end of the connector and the direct current power source based at least on the selected rate of charge.
Clause 6. The method of clause 4 wherein a maximum rate of charge is determined based on a maximum rate of charge accepted by the electric vehicle.
Clause 7. The method of clause 4 wherein a maximum rate of charge is determined based on a maximum rate of charge available from the direct current power source.
Clause 8. The method of any one of clauses 1 to 7, further comprising:

prior to charging the vehicle using the direct current power source, determining if the direct current power source is available; and

if the direct current power source is not available, charging the vehicle using the alternating current power source until the direct current power source is available.
Clause 9. The method of any one of clauses 1 to 8, further comprising:

communicating a notification to a mobile device of a user of the electric vehicle that the state of charge has exceeded the predefined state of charge level.
Clause 10. The method of any one of clauses 1 to 9, further comprising:

prompting a user to select one of an exclusive charge and a non-exclusive charge, wherein the exclusive charge is uninterruptable and the non-exclusive charge is interruptible.
Clause 11. A system comprising:

a direct current power source;

an alternating current power source;

a connector connectable at a first end to the direct current power source or the alternating current power source and at a second end to an electric vehicle; and

a processor programmed to:
charge the electric vehicle using the connector connected at the first end to the direct current power source and at the second end to the electric vehicle;
monitor a state of charge of the electric vehicle; and
when the state of charge exceeds a predefined state of charge level:
   disconnect the first end of the connector from the direct current power source;
   connect the first end of the connector to an alternating current source; and
   charge the electric vehicle using the connector connected at the first end to the alternating current source while the second end remains connected to the electric vehicle.
Clause 12. The system of clause 11, wherein the alternating power source comprises:

at least one battery generating direct current power; and

an inverter changing the direct current power to alternating current power.
Clause 13. The system of clause 11 or 12, wherein the direct current power source comprises:

at least one battery generating direct current power.
Clause 14. The system of clause 11 or 12 wherein the direct current power source comprises:

a plurality of sets of batteries generating direct current power.
Clause 15. The system of clause 14, further comprising:

a plurality of switches interconnecting the plurality of sets of batteries,

wherein the processor is programmed to:
communicate signals to the plurality of switches to selectively connect the plurality of sets of batteries to one another in at least one of a series connection and a parallel connection.
Clause 16. The system of clause 15, wherein during the disconnecting, the processor is programmed to:

communicate a signal to open at least one switch intermediate the first end of the connector and the direct current power source.
Clause 17. The system of clause 15, wherein during the connecting, the processor is programmed to:

communicate a signal to close at least one switch intermediate the first end the connector and the alternating current power source.
Clause 18. The system of any one of clauses 11 to 17, wherein the processor is programmed to:

prior to charging the vehicle using the direct current power source, determine if the direct current power source is available; and

if the direct current power source is not available, charge the vehicle using the alternating current power source until the direct current power source is available.
Clause 19. The system of any one of clauses 11 to 18, wherein the processor is programmed to:

communicate a notification to a mobile device of the user of the electric vehicle that the state of charge has exceeded the predefined state of charge level.
Clause 20. The system of any one of clauses 11 to 19, wherein the processor is programmed to:

prompt a user to select a rate of charge for charging the electric vehicle using the direct current power source;

communicate a signal to selectively open or close at least one switch intermediate the first end of the connector and the direct current power source based at least on the selected rate of charge; and

charge the electric vehicle at the selected rate of charge.
Clause 21. The system of clause 20, wherein the processor is programmed to:

determine a maximum rate of charge based on a maximum rate of charge accepted by the electric vehicle.
Clause 22. The system of clause 20, wherein the processor is programmed to:

determine a maximum rate of charge based on a maximum rate of charge available from the direct current power source.
Clause 23. The system of any one of clauses 11 to 22 wherein the connector is a SAE J1772 connector having Combined Charging System capability.
Clause 24. A non-transitory computer readable medium having stored thereon computer program code executable by one or more processors to:

communicate a signal to charge an electric vehicle using a connector connected at a first end to a direct current power source and at a second end to an electric vehicle;

monitor a state of charge of the electric vehicle; and

when the state of charge exceeds a predefined state of charge level:
communicate a signal to disconnect the first end of the connector from the direct current power source;
communicate a signal to connect the first end of the connector to an alternating current source; and
communicate a signal to charge the electric vehicle using the connector connected at the first end to the alternating current source while the second end remains connected to the electric vehicle.
Clause 25. A method comprising:

detecting a connection between an electric vehicle and an electric vehicle charging station;

prompting a user to select an exclusive charge or a non-exclusive charge;

determining a maximum rate of charge based on the selection; and

charging the electric vehicle using the electric vehicle charging station at the maximum rate of charge.
Clause 26. The method of clause 25 further comprising:

when the user selects the exclusive charge, the determining comprises:
setting the maximum rate of charge as the maximum rate of charge accepted by the electric vehicle when the maximum rate of charge accepted by the electric vehicle is available at the electric vehicle charging station without interrupting electric vehicles being charged non-exclusively.
Clause 27. The method of clause 25 further comprising:

when the user selects the exclusive charge, the determining comprises:
determining a maximum rate of charge available at the electric vehicle charging station by summing a rate of charge available at the electric vehicle charging station and rates of charge being used by other electric vehicles non-exclusively.
Clause 28. The method of clause 27, further comprising:

setting the maximum rate of charge as the maximum rate of charge accepted by the electric vehicle when the maximum rate of charge available at the electric vehicle charging station is greater than the maximum rate of charge accepted by the electric vehicle.
Clause 29. The method of clause 27, further comprising:

setting the maximum rate of charge as the maximum rate of charge available at the electric vehicle charging station when the maximum rate of charge available at the electric vehicle charging station is less than the maximum rate of charge accepted by the electric vehicle.
Clause 30. The method of any one of clauses 26 to 29 further comprising:

executing a switching sequence to charge the electric vehicle at the maximum rate of charge.
Clause 31. A system comprising:

a direct current power source;

a connector connectable at a first end to the direct current power source and at a second end to an electric vehicle; and

a processor programmed to execute the method of any one of clauses 26 to 31.
Clause 32. A non-transitory computer readable medium having stored thereon computer program code executable by one or more processors to perform the method of any one of clauses 26 to 31.

Although embodiments have been described above with reference to the accompanying drawings, those of skill in the art will appreciate that variations and modifications may be made without departing from the scope thereof as defined by the appended claims.

1. A method comprising:
charging an electric vehicle using a connector connected at a first end to a direct current power source and at a second end to the electric vehicle;
monitoring a state of charge of the electric vehicle; and
when the state of charge exceeds a predefined state of charge level:
disconnecting the first end of the connector from the direct current power source;
connecting the first end of the connector to an alternating current source; and
charging the electric vehicle using the connector connected at the first end to the alternating current source while the second end remains connected to the electric vehicle.

2. The method of claim 1 wherein the disconnecting comprises communicating a signal to open at least one switch intermediate the first end of the connector and the direct current power source.

3. The method of claim 1 wherein the connecting comprises communicating a signal to close at least one switch intermediate the first end the connector and the alternating current power source.

4. The method of claim 1 further comprising:
prompting a user to select a rate of charge for charging the electric vehicle using the direct current power source; and
charging the electric vehicle at the selected rate of charge.

5. The method of claim 4, further comprising communicating a signal to selectively open or close at least one switch intermediate the first end of the connector and the direct current power source based at least on the selected rate of charge.

6. The method of claim 4 wherein a maximum rate of charge is determined based on a maximum rate of charge accepted by the electric vehicle.

7. The method of claim 4 wherein a maximum rate of charge is determined based on a maximum rate of charge available from the direct current power source.

8. The method of claim 1, further comprising:
prior to charging the vehicle using the direct current power source, determining if the direct current power source is available; and
if the direct current power source is not available, charging the vehicle using the alternating current power source until the direct current power source is available.

9. The method of claim 1, further comprising:
communicating a notification to a mobile device of a user of the electric vehicle that the state of charge has exceeded the predefined state of charge level.

10. The method of claim 1, further comprising:
prompting a user to select one of an exclusive charge and a non-exclusive charge, wherein the exclusive charge is uninterruptable and the non-exclusive charge is interruptible.

11. A system comprising:
a direct current power source;
an alternating current power source;
a connector connectable at a first end to the direct current power source or the alternating current power source and at a second end to an electric vehicle; and
a processor programmed to:
charge the electric vehicle using the connector connected at the first end to the direct current power source and at the second end to the electric vehicle;
monitor a state of charge of the electric vehicle; and
when the state of charge exceeds a predefined state of charge level:
disconnect the first end of the connector from the direct current power source;
connect the first end of the connector to an alternating current source; and
charge the electric vehicle using the connector connected at the first end to the alternating current source while the second end remains connected to the electric vehicle.

12. The system of claim 11, wherein the alternating power source comprises:
at least one battery generating direct current power; and
an inverter changing the direct current power to alternating current power.

13. The system of claim 11, wherein the direct current power source comprises:
at least one battery generating direct current power.

14. The system of claim 11 wherein the direct current power source comprises:
a plurality of sets of batteries generating direct current power.

15. The system of claim 14, further comprising:
a plurality of switches interconnecting the plurality of sets of batteries,
wherein the processor is programmed to:
communicate signals to the plurality of switches to selectively connect the plurality of sets of batteries to one another in at least one of a series connection and a parallel connection.

16. The system of claim 15, wherein during the disconnecting, the processor is programmed to:
communicate a signal to open at least one switch intermediate the first end of the connector and the direct current power source.

17. The system of claim 15, wherein during the connecting, the processor is programmed to:
communicate a signal to close at least one switch intermediate the first end the connector and the alternating current power source.

18. The system of claim 11, wherein the processor is programmed to:
prior to charging the vehicle using the direct current power source, determine if the direct current power source is available; and
if the direct current power source is not available, charge the vehicle using the alternating current power source until the direct current power source is available.

19. The system of claim 11, wherein the processor is programmed to:
communicate a notification to a mobile device of the user of the electric vehicle that the state of charge has exceeded the predefined state of charge level.

20. The system of claim 11, wherein the processor is programmed to:
prompt a user to select a rate of charge for charging the electric vehicle using the direct current power source;
communicate a signal to selectively open or close at least one switch intermediate the first end of the connector and the direct current power source based at least on the selected rate of charge; and
charge the electric vehicle at the selected rate of charge.

21. The system of claim 20, wherein the processor is programmed to:
determine a maximum rate of charge based on a maximum rate of charge accepted by the electric vehicle.

22. The system of claim 20, wherein the processor is programmed to:
determine a maximum rate of charge based on a maximum rate of charge available from the direct current power source.

23. (canceled)

24. (canceled)

25. A method comprising:
detecting a connection between an electric vehicle and an electric vehicle charging station;
prompting a user to select an exclusive charge or a non-exclusive charge;
determining a maximum rate of charge based on the selection; and
charging the electric vehicle using the electric vehicle charging station at the maximum rate of charge.

26. The method of claim 25 further comprising:
when the user selects the exclusive charge, the determining comprises:
setting the maximum rate of charge as the maximum rate of charge accepted by the electric vehicle when the maximum rate of charge accepted by the electric vehicle is available at the electric vehicle charging station without interrupting electric vehicles being charged non-exclusively.

27. The method of claim 25 further comprising:
when the user selects the exclusive charge, the determining comprises:
determining a maximum rate of charge available at the electric vehicle charging station by summing a rate of charge available at the electric vehicle charging station and rates of charge being used by other electric vehicles non-exclusively.

28. The method of claim 27, further comprising:
setting the maximum rate of charge as the maximum rate of charge accepted by the electric vehicle when the maximum rate of charge available at the electric vehicle charging station is greater than the maximum rate of charge accepted by the electric vehicle.

29. The method of claim 27, further comprising:
setting the maximum rate of charge as the maximum rate of charge available at the electric vehicle charging station when the maximum rate of charge available at the electric vehicle charging station is less than the maximum rate of charge accepted by the electric vehicle.

30. The method of claim 26, further comprising:
executing a switching sequence to charge the electric vehicle at the maximum rate of charge.

31. (canceled)

32. (canceled)

33. A method comprising:
electrically connecting a direct current power source to an electric vehicle and charging the electric vehicle via the direct current power source;
during the charging, monitoring a state of charge of the electric vehicle; and
when the state of charge exceeds a defined state of charge level:
electrically disconnecting the electric vehicle from the direct current power source;
electrically connecting an alternating current power source to the electric vehicle; and
charging the electric vehicle via the alternating current power source.

34. The method of claim 32, wherein electrically disconnecting the electric vehicle from the direct current power source comprises communicating a signal to open at least one switch that electrically disconnects a connector extending to the electric vehicle from the direct current power source.

35. The method of claim 33, wherein electrically connecting the alternating current power source to the electric vehicle comprises communicating another signal to close at least one other switch that electrically connects the connector to the alternating current power source.

36. The method of claim 32, further comprising:
prompting a user to select a rate of charge for charging the electric vehicle via the direct current power source; and
charging the electric vehicle via the direct current power source at the selected rate of charge.

37. The method of claim 35, wherein a maximum rate of charge is determined based on one of (i) a maximum rate of charge accepted by the electric vehicle and (ii) a maximum rate of charge available from the direct current power source.

38. The method of claim 34, further comprising:
prior to charging the vehicle via the direct current power source, determining if the direct current power source is available; and
if the direct current power source is not available, charging the vehicle via the alternating current power source until the direct current power source is available.

39. The method of any one of claims 32 to 34, further comprising:
communicating a notification to a mobile device of a user of the electric vehicle that the state of charge has exceeded the defined state of charge level.

40. A method comprising:
physically connecting an electric vehicle to a power supply using a connector;
electrically connecting the electric vehicle to a direct current power source of the power supply and charging the electric vehicle via the direct current power source;
during the charging, monitoring a state of charge of the electric vehicle; and
when the state of charge exceeds a defined state of charge level and while maintaining the physical connection:
electrically disconnecting the electric vehicle from the direct current power source;
electrically connecting an alternating current power source of the power supply to the electric vehicle; and
charging the electric vehicle via the alternating current power source.

41. The method of claim 39, wherein electrically disconnecting the electric vehicle from the direct current power source comprises communicating a signal to open at least one switch to electrically isolate the connector from the direct current power source.

42. The method of claim 40, wherein electrically connecting the alternating current power source to the electric vehicle comprises communicating another signal to close at least one other switch to electrically connect the connector and the alternating current power source.
